(19) United States
(12) Patent Application Publication
(10) Pub. No.: US 2026/0156357 A1
(43) Pub. Date: Jun. 4, 2026

(54) DEVICE FOR IMAGING PLURALITY OF SUBJECTS OF DIFFERENT TYPES, METHOD FOR CONTROLLING DEVICE, AND NON-TRANSITORY COMPUTER-READABLE MEDIUM

(71) Applicant: CANON KABUSHIKI KAISHA, Tokyo (JP)

(72) Inventors: WATARU MATSUURA, Kanagawa (JP); ATSUSHI NOGAMI, Kanagawa (JP)

(21) Appl. No.: 19/389,715

(22) Filed: Nov. 14, 2025

(30) Foreign Application Priority Data
Nov. 29, 2024 (JP) 2024-208064

(51) Int. Cl. H04N 23/67; H04N 23/61; H04N 23/69

(52) U.S. Cl. CPC H04N 23/675; H04N 23/61; H04N 23/69

(57) ABSTRACT

A device for imaging multiple subjects is provided. The device includes a defocus range estimation part configured to estimate a defocus range for each of the subjects, a target determination part configured to set a combination of the defocus ranges, a defocus range setting part configured to set a control defocus range based on the set combination of the defocus ranges, and a control part configured to control image-taking conditions of the device based on the control defocus range.

### BACKGROUND

### Field of the Technology

The aspect of the embodiments relates to a device for imaging a plurality of subjects of different types, a method for controlling a device, and a non-transitory computer-readable medium.

### Description of the Related Art

There is known an imaging device that performs focus adjustment on the basis of multiple focus detection results within an imaging range to ensure that an intended subject is in focus. Japanese Patent Laid-Open No. 2012-181324 discloses a method for taking an image in which multiple subjects are in focus at the same time by adjusting the aperture and focus of a camera on the basis of distance information pertaining to multiple detected subjects.

In Japanese Patent Laid-Open No. 2012-181324, the distance information pertaining to a subject does not account for the spread of the subject in the depth direction, and thus it may not be possible to accurately bring the subject into focus in some cases.

### SUMMARY

The aspect of the embodiments is directed to a device for imaging a plurality of subjects of different types. The device includes at least one processor and at least one memory having stored thereon instructions which, when executed by the at least one processor, cause the device at least to: estimate a defocus range for each of the plurality of subjects; set a combination of a plurality of the defocus ranges; set a control defocus range based on the set combination of a plurality of the defocus ranges; and control image-taking conditions of the device based on the control defocus range.

The aspect of the embodiments is also directed to a method for controlling a device. The method involves: estimating a defocus range for each of a plurality of subjects of different types; setting a combination of a plurality of the defocus ranges; setting a control defocus range based on the set combination of a plurality of the defocus ranges; and controlling the device based on the control defocus range.

Features of the disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of a device according to the present disclosure.

FIG. 2 is a diagram of an imaging optical system for explaining a defocus amount in a first embodiment.

FIG. 3 is a diagram for explaining the configuration of an imaging device in the first embodiment.

FIG. 4A is a diagram for explaining a defocus range in the first embodiment.

FIG. 4B is a diagram for explaining a defocus range in the first embodiment.

FIG. 5 is an overall flowchart for the first embodiment.

FIG. 6A is a diagram for explaining processing by a target determination part in the first embodiment.

FIG. 6B is a diagram for explaining processing by a target determination part in the first embodiment.

FIG. 7 is a flowchart of target determination processing in the first embodiment.

FIG. 8 is a flowchart of range setting processing in the first embodiment.

FIG. 9A is a diagram for explaining defocus range setting processing in the first embodiment.

FIG. 9B is a diagram for explaining defocus range setting processing in the first embodiment.

FIG. 10 is a diagram for explaining the configuration of an imaging device in a second embodiment.

FIG. 11 is a flowchart of range setting processing in the second embodiment.

FIG. 12 is a flowchart of priority setting processing in the second embodiment.

FIG. 13A is a diagram for explaining priority setting processing in the second embodiment.

FIG. 13B is a diagram for explaining priority setting processing in the second embodiment.

FIG. 13C is a diagram for explaining priority setting processing in the second embodiment.

FIG. 13D is a diagram for explaining priority setting processing in the second embodiment.

FIG. 13E is a diagram for explaining priority setting processing in the second embodiment.

FIG. 13F is a diagram for explaining priority setting processing in the second embodiment.

FIG. 14A illustrates approximation formulas for calculating depth of field in the second embodiment.

FIG. 14B illustrates approximation formulas for calculating depth of field in the second embodiment.

### DESCRIPTION OF THE EMBODIMENTS

Hereinafter, the present disclosure will be described on the basis of exemplary embodiments, with reference to the attached drawings. Note that the configurations indicated in the following embodiments are merely examples, and the present disclosure is not limited to the configurations illustrated in the drawings.

### First Embodiment

An interchangeable-lens digital camera will be described as an example of a device according to the present disclosure.

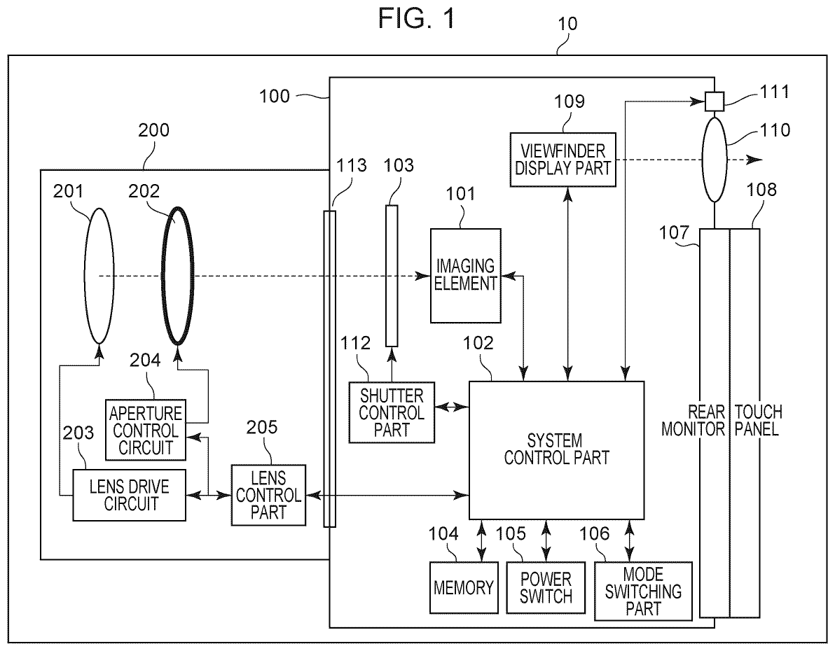

A first embodiment of the present disclosure will be described with reference to FIGS. 1 to 9B. FIG. 1 is a block diagram illustrating major system portions of an imaging device 10. The imaging device 10 is a lens-interchangeable digital camera, for example, and is configured to include a camera body 100 and a lens unit 200 that guides incident light to an imaging element 101 included in the camera body 100.

The camera body 100 includes the imaging element 101, a system control part 102, a shutter 103, a memory 104, a power switch 105, a mode switching part 106, a rear monitor 107, a touch panel 108, and a viewfinder display part 109. The camera body 100 further includes an eyepiece lens 110, an eye proximity detection part 111, a shutter control part 112, and a lens mount mechanism 113.

The imaging element 101 is a CMOS image sensor, for example, and converts an optical image, that is, an optical signal, into an electrical signal. Light rays entering an image-taking lens 201 in the lens unit 200 pass through an aperture 202 and the shutter 103 to form an optical image on the imaging element 101.

The system control part 102 has a well-known CPU or the like built in, and controls the camera body 100. The system control part 102 includes an image processing part that processes a video signal obtained by the imaging element 101. The system control part 102 also includes a phase detection AF part that performs focus detection processing according to the phase detection method on the basis of focus detection image data (phase detection AF signal) obtained from the imaging element 101 and the image processing part. More specifically, the image processing part generates, as the focus detection image data, a pair of image data formed by a light beam passing through a pair of pupil areas of the imaging optical system. The phase detection AF part detects an amount of focus shift on the basis the amount of shift between the pair of image data. In this way, the phase detection AF part of the present embodiment performs on-sensor phase detection AF based on the output of the imaging element 101, without using a dedicated AF sensor.

The memory 104 stores programs, variables, constants, and the like for use in the operation of the system control part 102. The memory 104 also includes an electrically erasable and writable non-volatile memory.

Various parameters, settings such as ISO sensitivity, image-taking modes, various corrective data, and the like are stored in the memory 104.

The power switch 105 switches the camera body 100 between a powered-on mode and a powered-off mode.

The mode switching part 106 is a switch for switching among and setting various image-taking modes, such as live-preview image-taking, video shooting, and the like.

The rear monitor 107 is configured as a liquid crystal display (LCD) device, one or more LEDs, and/or the like for displaying operating status, messages, and/or other image-taking information in the form of text, images, sound, and/or the like in response to the execution of a program by the system control part 102.

The touch panel 108 is disposed in substantially the same area as the rear monitor 107, detects contact made by a finger or stylus, notifies the system control part 102 of the contact position with respect to the rear monitor 107, and executes an operation or function associated with the contact position.

The viewfinder display part 109 displays image-taking information in response to the execution of a program by the system control part 102, in a manner similar to the rear monitor 107, and constitutes an electronic viewfinder (EVF) together with the eyepiece lens 110.

The eye proximity detection part 111 selectively causes the above-described image-taking information generated by the system control part 102 to be selectively displayed on the rear monitor 107 or the viewfinder display part 109, depending on the state of proximity of the eye of the operator.

Next, the configuration of the lens unit 200 will be described. The camera body 100 and the lens unit 200 are mechanically and electrically coupled via the lens mount mechanism 113, and the lens unit 200 is removable from the camera body 100. The lens unit 200 is configured to include the image-taking lens 201, the aperture 202, a lens drive circuit 203, an aperture control circuit 204, and a lens control part 205. FIG. 1 illustrates a single image-taking lens 201 for the sake of simplicity, but in actuality, the image-taking lens 201 is formed from a lens group of multiple image-taking lenses.

The aperture 202 is a mechanism for adjusting the amount of light entering the imaging element 101 via the lens, and is controlled by the aperture control circuit 204.

The lens drive circuit 203 is a drive circuit for moving the lens along an optical axis to adjust the focus position of the image plane.

The lens control part 205 controls the lens unit 200 as a whole. The lens control part 205 is provided with a memory, not illustrated, for storing various constants, variables, programs, and/or the like for use in lens operations.

The lens control part 205 is also provided with a non-volatile memory for retaining information specific to the lens unit, such as maximum and minimum aperture values, and the focal length.

The system control part 102 of the camera body 100 uses output information from the imaging element 101 to compute a defocus amount. The system control part 102 adjusts the focus by communicating via the lens control part 205 of the lens unit 200 and controlling the lens drive circuit 203 on the basis of the computed defocus amount.

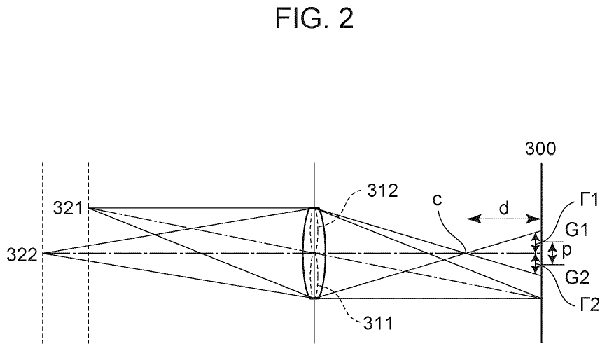

The following explains the defocus amount, which is used as image depth information in the present disclosure, using FIG. 2. FIG. 2 is a diagram for explaining the relationship between the defocus amount of an imaging optical system and the phase difference (image disparity) between a first focus detection signal and a second focus detection signal acquired from an imaging element.

An imaging element, not illustrated, is placed on an imaging surface 300 in FIG. 2, and the exit pupil of the imaging optical system is bisected into a first pupil area 311 and a second pupil area 312. The defocus amount d represents the distance from the image formation position C of a light beam from a subject (321, 322) to the imaging surface 300. The absolute value of this distance is expressed as |d|. The state in which the image formation position C is on the subject side of the imaging surface 300 is referred to as the front-focused state, and the defocus amount in this case is expressed as a negative value (d<0). The state in which the image formation position C is beyond the imaging surface 300 and on the opposite side from the subject is referred to as the back-focused state, and the defocus amount in this case is expressed as a positive value (d>0). In the in-focus state in which the image formation position C lies on the imaging surface 300, d=0. The imaging optical system illustrated in FIG. 2 is in the in-focus state (d=0) with respect to the subject 321, and is in the front-focused state (d<0) with respect to the subject 322. The front-focused state (d<0) and the back-focused state (d>0) are collectively referred to as the defocused state (|d|>0).

In the front-focused state (d<0), a portion of the light beam from the subject 322 passes through the first pupil area 311 and is condensed, after which a blurry image spreading out with a width of Γ1 centered on the center-of-gravity position G1 of the light beam is formed on the imaging surface 300. This blurry image is received by each first focus detection pixel on the imaging element, and a first focus detection signal is generated. In other words, the resulting first focus detection signal represents a subject image in which the subject 322 is blurred by an amount equal to the blur width of Γ1 at the center-of-gravity position G1 of the light beam on the imaging surface 300. Similarly, a portion of the light beam from the subject 322 passes through the second pupil area 312 and is condensed, after which a blurry image spreading out with a width of Γ2 centered on the center-of-gravity position G2 of the light beam is formed on the imaging surface 300. This blurry image is received by each second focus detection pixel on the imaging element, and a second focus detection signal is generated. In other words, the resulting second focus detection signal represents a subject image in which the subject 322 is blurred by an amount equal to the blur width of Γ2 at the center-of-gravity position G2 of the light beam on the imaging surface 300.

The blur width Γ1 and the blur width Γ2 of the subject image increase roughly proportionally with increases in the magnitude |d| of the defocus amount d. Similarly, the magnitude |p| of the image disparity p between the first focus detection signal and the second focus detection signal, which is the difference (G1−G2) between the center-of-gravity positions of the light beams, also increases roughly proportionally with increases in the magnitude |d| of the defocus amount d.

In the back-focused state, the direction of image disparity between the first focus detection signal and the second focus detection signal is the reverse of the front-focused state. The relationship of the defocus amount, the blur width, and the image disparity is similar to the case of the front-focused state.

As described above, the magnitude |p| of the image disparity between the first focus detection signal and the second focus detection signal increases as the magnitude |d| of the defocus amount d increases. In the present embodiment, focus detection is performed according to the on-sensor phase detection method, in which the defocus amount d is calculated the image disparity p between the first focus detection signal and the second focus detection signal obtained using the imaging element 101. Consequently, the phase detection AF part of the system control part 102 converts the image disparity p into a detected defocus amount d.

A conversion coefficient is calculated on the basis of the base length, in consideration of the relationship in which the magnitude |p| of the image disparity between the first focus detection signal and the second focus detection signal increases as the magnitude |d| of the defocus amount of the imaging signal increases. Note that for the units of the defocus amount d in the present embodiment, the product “Fδ” of the aperture F-number and the permissible circle of confusion δ in the imaging device optical system at the time of image-taking is used.

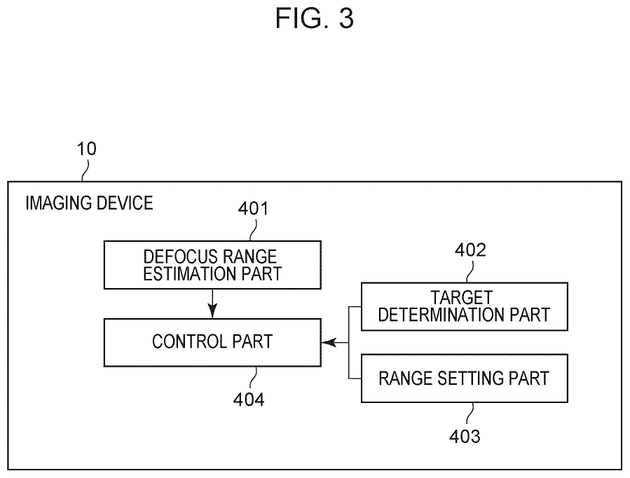

Operations by the device according to the present embodiment will be described with reference to FIGS. 3 to 9B. FIG. 3 is a diagram for explaining the configuration of the imaging device 10 according to the first embodiment. The imaging device 10 is configured to include a defocus range estimation part 401, a target determination part 402, a range setting part 403, and a control part 404.

The defocus range estimation part 401 distinguishes between types of subjects and estimates a defocus range for individual parts of each subject. The defocus range refers to the value range of the defocus amount that a subject has.

In the target determination part 402, a combination of multiple subjects combining defocus ranges estimated by the defocus range estimation part 401 is determined.

In the range setting part 403, a control defocus range, which is a combination of defocus ranges, is changed on the basis of the combination determined by the target determination part 402. In other words, the range setting part 403 sets a new defocus range.

In the control part 404, a drive amount for the image-taking lens 201 is calculated on the basis of the control defocus range changed by the range setting part 403, and the focus position is controlled. Also, in the aperture 202, the depth of field (DoF) is adjusted. In other words, the control part 404 controls imaging conditions on the basis of the control defocus range.

The following describes the defocus range estimation part 401 in detail. A variety of models are conceivable as the defocus range estimation part 401. Examples include a neural network using a convolutional neural network (CNN), Vision Transformer (ViT), and a support vector machine (SVM) combined with a feature extractor. In the present embodiment, the defocus range estimation part 401 uses a defocus map calculated by the phase detection AF part of the system control part 102, image data including a subject detection area, and the position and the size of the subject detection area as input for defocus range estimation. Note that the defocus map refers to information pertaining to a defocus amount distribution in which defocus amounts are assigned to a certain number of pixels of the imaging surface. For example, in a case where a person is treated as a subject, image data of an area containing the subject detection area is used as the image data of the input. Likewise, a portion of the defocus map corresponding to the subject detection area is used as the input.

The defocus range estimation part 401 according to the present embodiment includes a subject detection part, not illustrated. The subject detection part performs subject detection processing, to be described later, on the basis of a signal for subject detection generated by the system control part 102. Through the subject detection processing, a subject detection area indicating the type and the state of a subject, as well as the position and the size of the subject for individual parts of the subject, is detected. Image information including information about an area within the image where a subject is detected by the subject detection part, the defocus map detected by the phase detection AF of the system control part 102, and the like are accepted as input, and the defocus range estimation part 401 outputs a defocus range for each subject.

The subject detection part is configured as a CNN that has been trained by machine learning, and is a well-known object detector that performs whole area detection and local area detection of specific subjects. The subjects for which whole area detection and local area detection are available are predefined during the training of the object detector by machine learning. The subject detection part may also be achieved by a graphics processing unit (GPU) and/or a specialized circuit for CNN-based estimation processing.

The CNN may be trained by any machine learning approach. For example, a prescribed computer such as a server may train the CNN by machine learning, and the imaging device 10 may acquire the trained CNN from the prescribed computer. In the present embodiment, it is assumed that the prescribed computer trains the CNN of the subject detection part by performing supervised learning in which image data for training is accepted as input, and subject position information corresponding to the image data for training is used as labeled training data. Note that the CNN may also be trained by the imaging device 10.

As described above, the subject detection part includes a trained model, namely a CNN that has been trained by machine learning. The subject detection part accepts image data as input, estimates the position and the size of a subject, a confidence level, and/or the like, and outputs the estimated information. The CNN may also be, for example, a network in which a fully connected layer and an output layer are connected in a layer structure with alternating layers of convolutional layers and pooling layers. In this case, for example, error backpropagation or the like may be applied as the training of the CNN. The CNN may also be a neocognitron CNN made up of a set of feature detection layers (S-layers) and feature integration layers (C-layers). In this case, the training approach referred to as “Add-if Silent” may be applied as the training of the CNN.

Any trained model other than a trained CNN may also be used for the subject detection part. For example, a trained model generated by machine learning, such as a support vector machine or a decision tree, may also be applied to the subject detection part. Moreover, the subject detection part need not be a trained model generated by machine learning. For example, any subject detection approach that does not make use of machine learning may also be applied to the subject detection part.

In this context, the type of a subject refers to a classification of each subject corresponding to the estimation of a defocus range in the defocus range estimation part 401. Examples of subject classifications include humans, animals, and vehicles. Animals may be further sub-classified into horses, birds, and so on. Also, a part of a subject refers to a defined area, such as whole area or local area, for which defocus range estimation is supported by the defocus range estimation part 401.

A whole area may literally refer to an area containing an entire subject being set as an area, or may refer to an area containing a major portion of a subject being set as an area. For example, in the case of the whole area of a subject belonging to “vehicles”, the whole area can be defined for each individual type of subject, such as the “vehicle body” of an automobile or a motorcycle, the “lead car” of a railway train, or the “fuselage” of an aircraft.

A local area refers to a partial area of a subject identified in a whole area. For example, a localized area included in a whole area is set, such as setting “eye of person” as a local area with respect to “entire face of person” as the whole area, or setting “eye of animal” as a local area with respect to “entire face of animal” as the whole area. The positional relationship may also be such that a local area is not included in a whole area, such as setting “helmet of driver” sticking out from the vehicle body of a motorcycle as a local area with respect to “entire vehicle body of motorcycle” as the whole area. The types and the part of subject described above correspond to detection results from the subject detection part, and are associated with the position and the size of a subject detection area.

The defocus range estimation part 401 distinguishes between types of subjects, such as the eye of a human and the face of a horse, on the basis of the position and the size of a subject detection area, and estimates a defocus range for individual parts of each subject. The defocus range estimation part 401 outputs a range of values that the defocus amount may take for each subject detection area as the defocus range for that subject. For example, the two values of a maximum value and a minimum value for the defocus amount of an eye are outputted with respect to a subject detection area (eye).

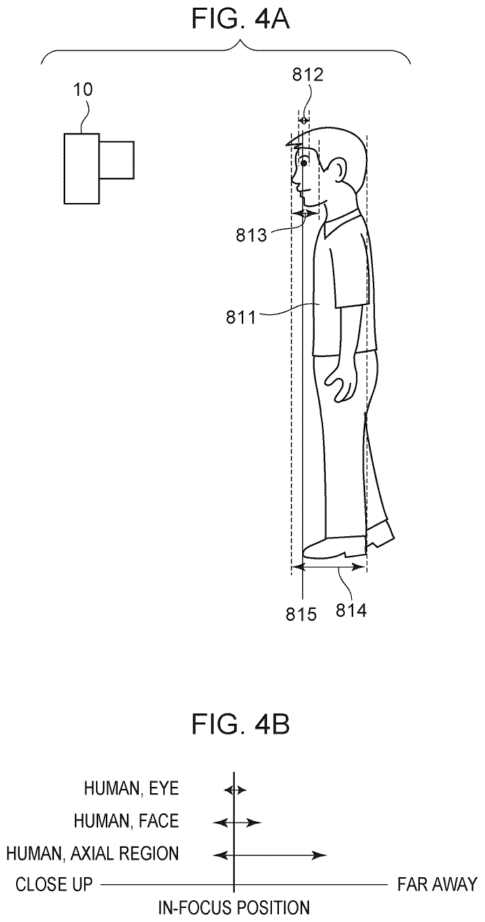

FIGS. 4A and 4B are diagrams for explaining defocus ranges. FIG. 4A illustrates a state in which an image of a human 811 is taken using the imaging device 10. In FIG. 4A, 812, 813, and 814 represent the spread of the eye of the human, the face of the human, and the axial region of the human, respectively, as objects in the depth direction as viewed from the imaging device 10. Also, 815 represents the in-focus position for the imaging device 10, and thus illustrates that the imaging device 10 is in focus at the position of the eye 812 of the human.

In FIG. 4B, the defocus ranges for the eye 812 of the human, the face 813 of the human, and the axial region 814 of the human are represented in a schematic diagram. In FIG. 4B, the horizontal axis represents the defocus amount, and the length of a line segment represents the defocus range, that is, the value range of the defocus amount. The side closer to the imaging device 10 is denoted as close up, and the side farther away from the imaging device 10 is denoted as far away.

As an example, in FIG. 4A, the spread of the axial region 814 of the human as an object in the depth direction as viewed from the camera is located at the tip of the nose of the human for example on the most close-up side, and is located at the tip of the shoulders of the human for example on the most far-away side. For this reason, the maximum value (most close-up value) of the defocus amount of the axial region 814 of the human is the defocus amount indicating the tip of the nose of the human, and the minimum value (most far-away value) of the defocus amount is the defocus amount indicating the tip of the shoulders of the human. The value range defined from the maximum value to the minimum value is the defocus range for the axial region 814 of the human. In FIG. 4B, the line segment corresponding to the axial region of the human represents the relationship of the defocus amounts. The most close-up value of the defocus amount is 0.2 Fδ for example, and the most far-away value is −1.4 Fδ for example. In this way, the defocus range estimation part 401 estimates defocus ranges by accounting for the close-up/far-away relationship in the depth direction of the object of estimation, such as the eye, the face, and/or the axial region of a human.

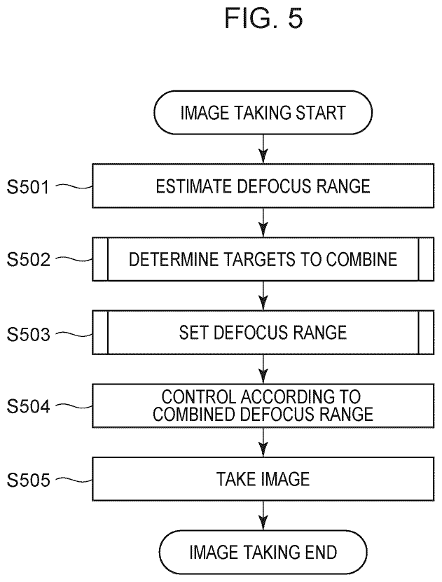

FIG. 5 illustrates a flowchart for the device as a whole according to the present embodiment.

When the imaging device 10 starts image-taking, in step S501, the defocus range estimation part 401 estimates a defocus range for each of multiple subjects within the imageable area. The estimation of a defocus range is achieved by model that has been trained by machine learning to accept a defocus map, image data including a subject detection area, and the position and the size of the subject detection area as input, and to output a defocus range for each subject area. The model is created by carrying out training using data expressing a defocus map, image data including a subject detection area, and the position and the size of the subject detection area, paired with ground truth data expressing a defocus range for each subject area. An existing approach such as deep learning may be used for the machine learning.

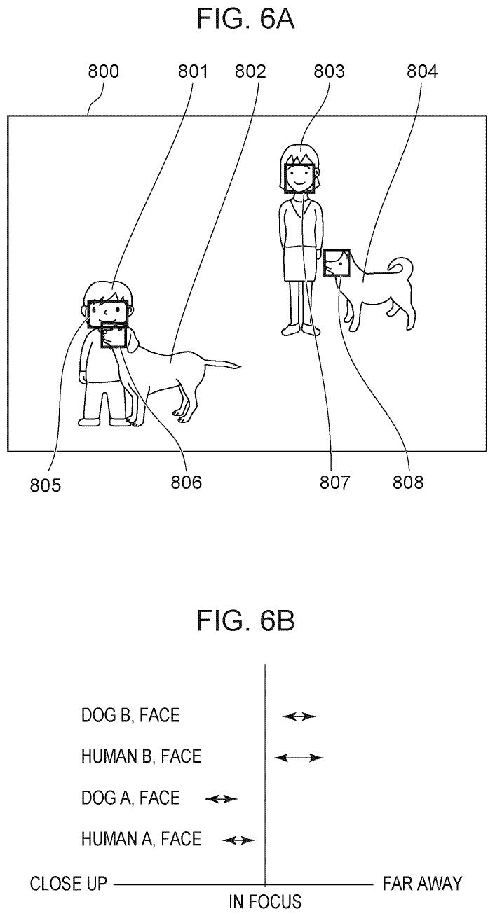

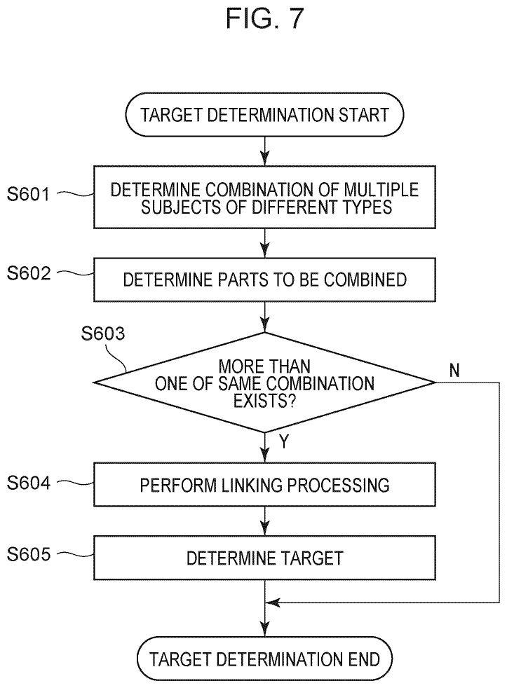

Next, as step S502, the target determination part 402 determines a combination of multiple types of subjects for which a defocus range was estimated in step S501. FIGS. 6A and 6B are diagrams for explaining the processing in step S502. A flowchart of the processing in step S502 is illustrated in FIG. 7.

FIG. 6A illustrates a case where multiple subjects of different types are present in an image 800 captured in step S501. In the image 800 a human A 801, a dog A 802, a human B 803, and a dog B 804 are present as subjects. Also, among the subject detection areas acquired in step S501, the face 805 of the human A, the face 806 of the dog A, the face 807 of the human B, and the face 808 of the dog B are displayed as respective detection frames.

In FIG. 6B, the defocus range estimation results acquired in step S501 for the human A 801, the dog A 802, the human B 803, and the dog B 804 in FIG. 6A are represented in a schematic diagram, and the respective defocus ranges for a local area, namely the face of each subject, are displayed. The horizontal axis represents the magnitude of the defocus amount, and the length of a line segment represents the defocus range. In FIG. 6B, the defocus ranges for the face 805 of the human A, the face 806 of the dog A, the face 807 of the human B, and the face 808 of the dog B are respectively displayed. For example, the left end of the line segment corresponding to the face 805 of the human A indicates the most front-focused defocus value among the pixels in the range of the face 805 area of the human A.

Similarly, the right end of the line segment corresponding to the face 805 of the human A indicates the most back-focused defocus value among the pixels in the range of the face 805 area of the human A, and the entire line segment indicates the defocus range for the face area of the human A.

Processing for determining which defocus ranges are to be combined in step S502 will be described using FIG. 7.

In step S601, the target determination part 402 determines a combination of multiple subjects of different types. In the present embodiment, the user selects a combination on the touch panel 108 from among preset combination candidates. Combination candidates refer to combinations of types of subjects, such as a human and a horse, or a human and a horse and a bird, for example, in which two or more types of subjects are selected from among classifications for which defocus range estimation is supported by the defocus range estimation part 401. The presets list all possible combinations of classifications for which defocus range estimation is supported by the defocus range estimation part 401. If the defocus range estimation part 401 supports n classifications, then there are 2ⁿ−1 possible combinations. An upper limit may also be imposed on the number n of classifications to limit the number of candidates when the user selects a combination. The user may also be given the opportunity to select a combination from among candidates that have narrowed down to a subset of combinations from the presets to suit the needs of the user.

The user may also specify a combination candidate in advance so that a user-desired combination is selected without having to make a selection manually. In step S601, the target determination part 402 determines the combination of a human and a dog, for example, as the combination of multiple subjects of different types.

In step S602, the target determination part 402 determines parts for which the defocus ranges are to be combined from among the subjects for which the defocus ranges are to be combined. In the current step, the target determination part 402 determines which parts are to have the defocus ranges combined from among the defocus ranges for the multiple subjects of different types estimated by the defocus range estimation part 401. The parts for which the defocus ranges are to be combined may be any parts for which a defocus range for each subject can be limited. In the present embodiment, priority is given to selecting a local area of each subject.

The following gives an example of the case of combining a defocus range for a human and a defocus range for a dog from the combination of a human and a dog determined in step S601. It is assumed that in the defocus range estimation part 401, a defocus range for the axial region of a human, which is a whole area of a human, and a defocus range for the face of a human, which is a local area of a human, are successfully acquired. Similarly, it is assumed that a defocus range for the axial region of a dog, which is a whole area of a dog, and a defocus range for the face of a dog, which is a local area of a dog, are successfully acquired. At this time, in step S602, the parts for which defocus ranges are to be combined are determined to be the local areas of the subjects, namely the face of the human and the face of the dog. The parts for which defocus ranges are to be combined may also be specific parts that the user has specified in advance. In a case where defocus ranges for multiple local areas are successfully acquired, the defocus ranges may be combined and deemed a single part. For example, in a case where a defocus range for the left eye is successfully acquired and a defocus range for the right area is successfully acquired as local areas of a human, a defocus range combining the defocus ranges may be deemed the defocus range for the eyes of the human. The eyes of the human for which a defocus range is obtained by combining may be further combined with the defocus range for another subject and treated as a single part.

In step S603, the target determination part 402 determines whether or not more than one of the same combination of subjects exists in the image. If there is more than one of the same combination of subjects, the combinations are distinguished and each is determined as a target for which defocus ranges are to be combined.

The following gives an example of the case of determining to combine a defocus range for a human and a defocus range for a dog in step S601. If two or more combinations of a human and a dog exist in the image, the flow advances to step S604, whereas if not, the processing by the target determination part is ended and the flow advances to the processing in S503. In the present embodiment, it is inferred that the same combination of subjects exists if the defocus range estimation results acquired in step S501 indicate the existence of multiple defocus ranges for the subjects determined in step S601.

In step S604, if it is determined in step S603 that more than one of the same combination of subjects exists, the target determination part 402 performs processing for linking subjects together so that the defocus ranges are combined according to the combination determined in step S601. In the present embodiment, subjects with the maximum Intersection over Union (IoU) of subject detection areas and a common defocus range are linked together.

As an example, consider the case where, in FIG. 6A, a human and a dog are determined in step S601 as the subjects for which defocus ranges are to be combined, and the face of a human and the face of a dog are obtained in step S602 as the parts for which defocus ranges are to be combined. The targets for which linking is to be verified in step S604 are all combinations of a subject detection area indicating the face of a human and a subject detection area indicating the face of a dog. In the case of FIG. 6A, the IoU is calculated for each of the face 806 which is a subject detection area of the dog A 802 or the face 808 which is a subject detection area of the dog B 804 with respect to the face 805 which is a subject detection area of the human A 801 or the face 807 which is a subject detection area of the human B 803. The IoU is 0 for the human A 801 and the dog B 804, for the human B 803 and the dog A 802, and for the human B 803 and the dog B 804, but the IoU is for example 0.2 for the human A 801 and the dog A 802.

It is also determined whether or not the combinations of targets for which the IoU is calculated are subjects with a common defocus range. In the case of FIG. 6B, it is determined whether or not the defocus range for the face of the dog A 802 or the defocus for the face of the dog B 804 overlaps with the defocus range for the face of the human A 801 or the defocus range for the face of the human B 803. In the case of FIG. 6B, a range where the defocus ranges overlap does not exist for the combination of the face of the human A 801 and the face of the dog B 804 or for the combination of the face of the human B 803 and the face of the dog A 802. On the other hand, it is determined that a range where the defocus ranges overlap exists for the combination of the face of the human A 801 and the face of the dog A 802 and for the combination of the face of the human B 803 and the face of the dog B 804.

Thus, in the linking processing in step S604, the target determination part 402 determines the combination of the defocus range for the face of the human A 801 and the defocus range for the face of the dog A 802 as linking targets. Likewise, in the linking processing in step S604, the target determination part 402 determines the combination of the defocus range for the face of the human B 803 and the defocus range for the face of the dog B 804 as linking targets. Such linking processing is performed to uniquely determine a focusing target from among the linked targets, and to control the imaging device 10. For example, in the case where the face of the human A 801 and the face of the dog A 802 are determined as the focusing target, the imaging device 10 is controlled so that a new defocus range based on the defocus ranges for the determined focusing target falls within the in-focus range. This makes it possible to take an image in which both the human A 801 and the dog A 802 are both in focus.

Note that in the present embodiment, subjects with the maximum IoU and overlapping defocus ranges are obtained as targets to be linked together, but linking may also be performed on a combination of subjects for which the center coordinates of the subject detection areas are the shortest distance apart, for example. Moreover, besides linking based on whether or not the defocus ranges are overlapping, linking may also be performed on subjects for which the maximum value or the minimum value of the defocus ranges are closest to one another, or on subjects for which an intermediate value of the defocus ranges are closest to one another.

In step S605, a target for which defocus ranges are to be combined is uniquely determined from among the combinations of subjects linked in step S604. In the present embodiment, the defocus ranges for the combinations of subjects linked in S604 are compared, and the combination having defocus ranges on the close-up side is determined as the target. As an example, consider the case where, in step S604, the combination of the defocus range for the face of the human A 801 and the defocus range for the face of the dog A 802 is linked, and the combination of the defocus range for the face of the human B 803 and the defocus range for the face of the dog B 804 is linked. The most close-up value (maximum value) of the defocus ranges for the face of the human A 801 and the face of the dog A 802 linked in S604 and the most close-up value (maximum value) of the defocus ranges for the face of the human B 803 and the face of the dog B 804 linked in S604 are compared in FIG. 6B. It can be determined that the maximum value of the defocus ranges for the face of the human A 801 and the face of the dog A 802 is greater than the maximum value of the defocus ranges for the face of the human B 803 and the face of the dog B 804. As a result, in FIGS. 6A and 6B, the face of the human A 801 and the face of the dog A 802 are determined as the subjects for which defocus ranges are to be combined. This completes the target determination processing in step S502.

In step S503, the range setting part 403 sets a defocus range on the basis of the combination of subjects set by the target determination part 402.

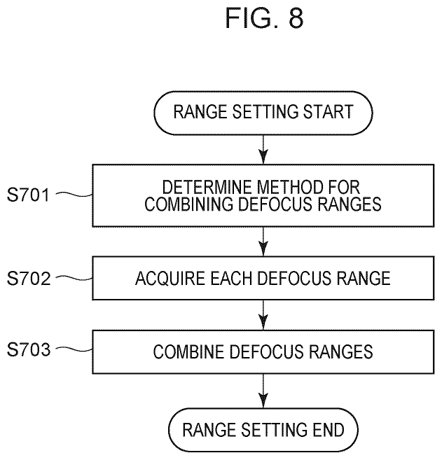

A flowchart of the processing in step S503 is illustrated in FIG. 8.

In step S701, the range setting part 403 determines a method for combining defocus ranges on the basis of the combination of subjects determined by the target determination part 402. In the present embodiment, the range setting part 403 combines defocus ranges so as to include the range from the most close-up defocus range to the most far-away defocus range among the respective defocus ranges for the multiple subjects.

In step S702, the range setting part 403 acquires the defocus ranges for the parts of the subjects determined to be combined by the target determination part 402.

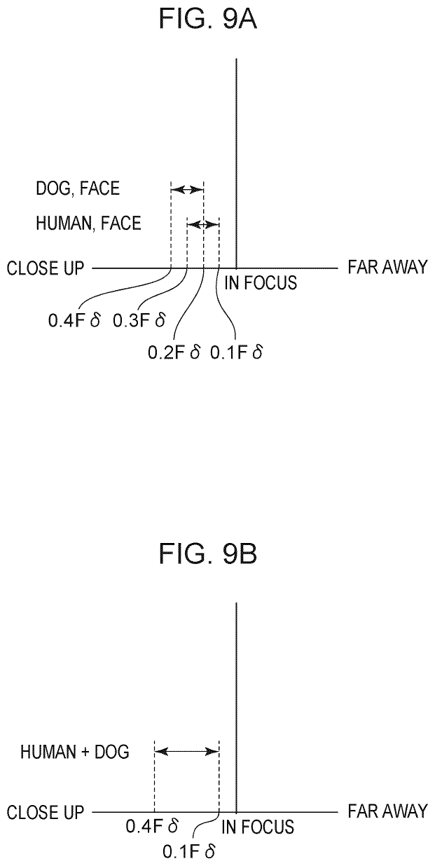

FIGS. 9A and 9B are diagrams for explaining defocus range setting processing by the range setting part 403.

In FIG. 9A, the defocus ranges for individual parts are illustrated as respective line segments for the case where the combination of subjects determined by the target determination part 402 is the face of a human and the face of a dog. The diagram illustrates the case where the acquired defocus ranges are such that, for example, the defocus range for the face of the human is 0.1 Fδ to 0.3 Fδ and the defocus range for the face of the dog is 0.2 Fδ to 0.4 Fδ.

In step S703, the range setting part 403 combines the defocus ranges acquired in step S702 according to the method determined in step S701. In the present embodiment, the maximum values of the defocus ranges acquired in step S702 are compared with each other, the minimum values of the same are compared with each other, and a combined defocus range is determined. In other words, the defocus ranges for the parts determined to be combined by the target determination part 402 are compared with each other, and the maximum value and the minimum value for all of the combined defocus ranges are selected. That is, the values of the most close-up defocus amount and the most far-away defocus amount included in the combination of defocus ranges set by the target determination part 402 are set as the maximum value and the minimum value of a new defocus range.

In FIG. 9B, the defocus range obtained as a result of the defocus ranges acquired in FIG. 9A being combined in the current step is illustrated as a line segment. As mentioned above, in FIG. 9A, the defocus range for the face of the human is 0.1 Fδ to 0.3 Fδ and the defocus range for the face of the dog is 0.2 Fδ to 0.4 Fδ. Among these defocus ranges, the most close-up defocus amount is 0.4 Fδ corresponding to the face of the dog and the most far-away defocus amount is 0.1 Fδ corresponding to the face of the human. Therefore, the defocus range in the case of combining the person and the dog is 0.1 Fδ to 0.4 Fδ.

In S504, the imaging device 10 is controlled by the control part 404 on the basis of a result from the range setting part 403. The control part 404 controls the image-taking lens 201 and the aperture 202 on the basis of the new defocus range set in step S503. In the present embodiment, a drive amount necessary for control of the image-taking lens 201 is calculated from the defocus amount in the center of the defocus range set in S503, and the focus is controlled. Also, the control of the aperture involves not only adjusting the amount of incident light but also adjusting the depth of field (DoF). It is possible to use information about the defocus range set in S503 to adjust the aperture and control the extent to which multiple subjects of different types are included in the depth of field. For example, by adjusting the aperture so that the defocus range for each subject falls within a unit depth determined from the permissible circle of confusion, it is possible to achieve camera control that is in focus on each of the multiple subjects of different types.

As S505, an image is taken by the imaging device 10 on the basis of the result of the control in S504. In the device according to the present embodiment, it is possible to take an image in which multiple subjects are correctly in focus, while accounting for the spread of the subjects in the depth direction.

Note that in the present embodiment, the defocus range estimation part 401 is configured to include the subject detection part, but this configuration is merely an example. The defocus range estimation part 401 may also be configured to estimate a position, an area, and/or a defocus range for individual parts of subjects, for example.

### Modification 1

In the first embodiment, the user manually selects a subject combination candidate in step S601. However, the subject combination candidate may also be set without being selected manually.

For example, a combination of subjects may be set on the basis of a trend of image-taking by the user. If the user has consecutively selected the same combination of subjects in step S601 a certain number of times or more, then in step S601 for subsequent imaging, that combination is deemed to be the user-desired combination and is set as the combination. For example, if the user has consecutively selected the combination of a human and a horse in step S601 10 times or more, then in the processing in the next step S601, the combination of a human and a horse is determined as the target for which defocus ranges are to be combined, without an operation by the user.

A combination of subjects may also be set according to an estimation result obtained by the defocus range estimation part 401 and/or a result detected by the subject detection part.

For example, in a case where a defocus range estimation result is acquired in step S501 and a specific subject is successfully authenticated by the subject detection part, a combination of subjects is set in step S601 on the basis of the authentication result. Authentication refers to, in the case where the subject is a human for example, identifying a human appearing in an image by storing an image of a human to be authenticated in the memory 104 or the like in advance. If two specific humans are authenticated by the subject detection part in step S501, then in the processing in the next step S601, the two humans authenticated in step S501 are set as the combination of subjects for which defocus ranges are to be combined.

In a case where a defocus range estimation result is acquired in step S501 and defocus range estimation result for a specific subject is acquired by the subject detection part a certain number of times or more, it is inferred that image-taking is being performed under certain image-taking conditions, and a preset combination of subjects is set. For example, if a defocus range estimation result for a human and a horse is consecutively acquired in step S501 10 times or more, it is inferred that image-taking at a horse racing venue is being performed, and in the processing in the next step S601, the preset combination of a human and a horse is determined. The user may also be given the opportunity to set the determined combination in advance.

The present modification allows for a lessening of the user burden of manually selecting a combination of subjects. Also, the setting of a combination of subjects described above may also be used to recommend combination candidates to the user. The user then manually selects a desired combination from among the recommended combinations of subjects. Providing recommendations in this way may prevent the user from selecting an unintended combination.

### Modification 2

In step S701 of the first embodiment, the range from the most close-up defocus range to the most far-away defocus range among the defocus ranges for multiple subjects is set as a new defocus range, but a defocus range common to multiple subjects may also be set as the new defocus range.

In the present modification, when the defocus ranges acquired in step S702 are compared in step S703, a common defocus range is determined from among the respective defocus ranges for each of the subjects acquired in step S702. In other words, the defocus ranges for the parts determined to be combined are compared with each other, and the range where all of the defocus ranges overlap is determined. The following gives an example of the case where the defocus ranges acquired in S702 are −0.1 Fδ to 0.2 Fδ corresponding to the face of a human and 0.1 Fδ to 0.7 Fδ corresponding to the face of a dog. In step S703, as a result of comparing the defocus ranges, the obtained defocus range is 0.1 Fδ to 0.2 Fδ.

By setting a defocus range common to multiple subjects as the new defocus range, a narrower range can be set as the defocus range compared to the case of setting the range from the most close-up defocus range to the most far-away defocus range for the multiple subjects as the new defocus range. As a result, when controlling the aperture 202 in step S504, image-taking adjusted to have a shallower depth of field can be performed.

### Second Embodiment

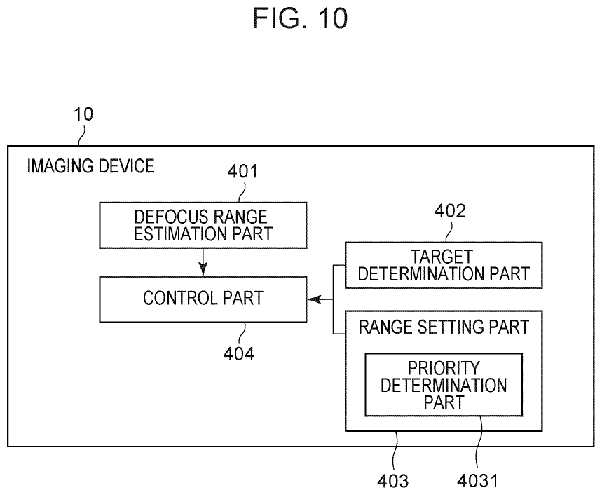

A second embodiment will be described using FIGS. 10 to 14B. A description will be omitted for portions in common with the first embodiment, and mainly the differences from the first embodiment will be described. In the present embodiment, priority is set for a defocus range, and defocus ranges are combined according to the priority.

FIG. 10 is a diagram for explaining an imaging device 10 according to the present embodiment. A defocus range estimation part 401, a target determination part 402, and a control part 404 in the present embodiment are similar to those in FIG. 2 of the first embodiment.

In the imaging device 10 according to the present embodiment, a range setting part 403 is provided with a priority determination part 4031. The priority determination part 4031 determines which defocus range has priority when the defocus ranges for multiple subjects of different types are to be combined by the range setting part 403.

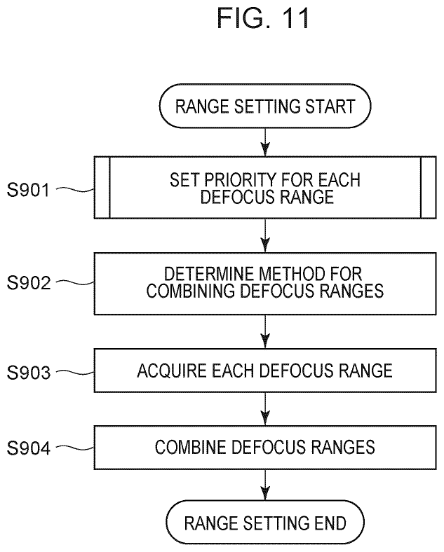

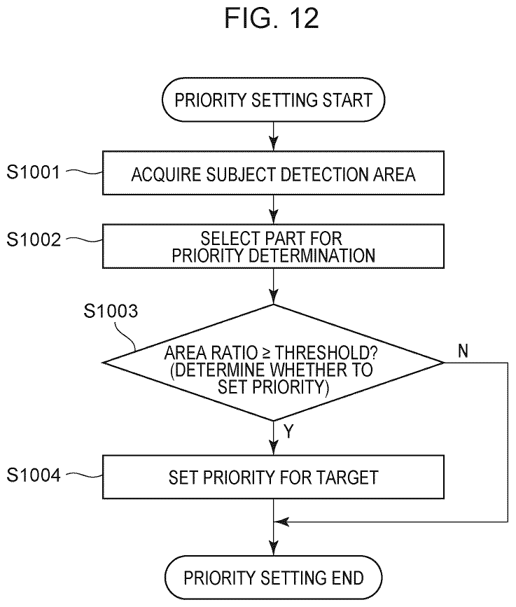

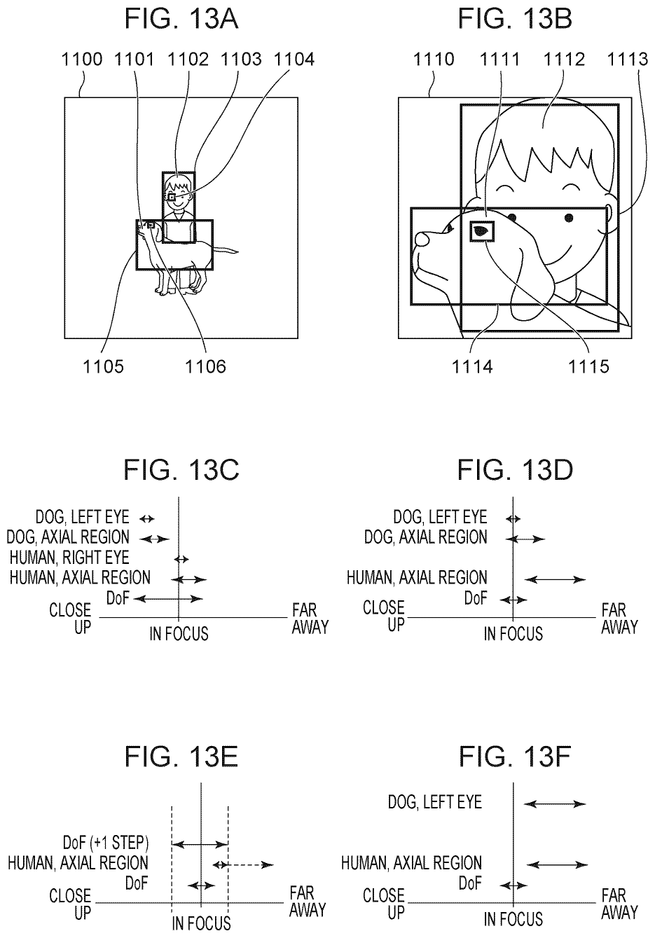

FIG. 11 illustrates a flowchart of processing by the range setting part 403 in the present embodiment. The flow from the processing for determining the method for combining defocus ranges in step S902 to the processing for combining defocus ranges in step S904 is similar to the flow of the processing indicated in steps S701 to S703 of FIG. 8 of the first embodiment. Priority setting processing in step S901 will be described in detail using FIGS. 12 and 13.

FIGS. 13A to 13F are diagrams for explaining the priority setting processing in step S901. FIG. 13A illustrates a case where multiple subjects of different types are present in an image 1100. In the image 1100, a dog 1101 and a human 1102 are shot as subjects. Among the subject detection areas acquired by the subject detection part of the defocus range estimation part 401, the left eye 1106 of the dog, which serves as a local area of the dog 1101, and the right eye 1104 of the human, which serves as a local area of the human 1102, are displayed in the image as detection frames. Similarly, the axial region 1105 of the dog, which serves as a whole area of the dog 1101, and the axial region 1103 of the human, which serves as a whole area of the human 1102, are displayed in the image as detection frames.

In FIG. 13C, the results obtained from the defocus range estimation part 401 performing defocus range estimation on the subjects illustrated in FIG. 13A are represented in a schematic diagram. The horizontal axis represents the magnitude of the defocus amount, and the length of a line segment represents the defocus range. In FIG. 13C, the defocus ranges for the local areas, namely the left eye 1106 of the dog and the right eye 1104 of the human, and the defocus ranges for the whole areas, namely the axial region 1105 of the dog and the axial region 1103 of the human, are displayed. Also, DoF represents the depth of field in FIG. 13A.

FIG. 13B is an illustration of a case where multiple subjects of different types are shot up close in an image 1110. A dog 1111 and a human 1112 are shot as subjects. Among the subject detection areas acquired by the subject detection part of the defocus range estimation part 401, the left eye 1115 of the dog, which serves as a local area, and the axial region 1114 of the dog and the axial region 1113 of the human, which serve as whole areas, are displayed in the image as detection frames.

In FIG. 13D, the results obtained from the defocus range estimation part 401 performing defocus range estimation on FIG. 13B are represented in a schematic diagram. The defocus range for the left eye 1115 of the dog as a local area and the defocus ranges for the axial region 1114 of the dog and the axial region 1113 of the human as whole areas are displayed.

In FIGS. 13E and 13F, the results of setting priority for the defocus range estimation results in FIG. 13D are represented in a schematic diagram.

FIG. 12 illustrates a flowchart of priority setting processing in the present embodiment.

In step S1001, the defocus range estimation part 401 acquires the position and the size of each subject detection area detected by the subject detection part. For example, in the case of FIG. 13A, information pertaining to a subject detection area is acquired for the left eye 1106 as a local area and for the axial region 1105 as a whole area of the dog 1101. Likewise, information pertaining to a subject detection area is acquired for the right eye 1104 as a local area and for the axial region 1103 as a whole area of the human 1102. On the other hand, in the case of FIG. 13B, information pertaining to a subject detection area is acquired for the left eye 1115 as a local area and for the axial region 1114 as a whole area of the dog 1111. Since the right eye of the human 1112 is obscured by the dog 1111, the right eye cannot be detected as a local area. As a result, the left eye 1115 and the axial region 1114 of the dog 1111 and the axial region 1113 of the human 1112 are acquired as information pertaining to subject detection areas.

Next, in step S1002, the priority determination part 4031 selects a part for priority determination from among the subject detection areas acquired in step S1001. In the present embodiment, a whole area among the subject detection areas acquired in step S1001 is selected as the part for priority determination. In the case of the human 1102 in FIG. 13A, the position and the size are acquired for the right eye 1104 as a local area and for the axial region 1103 as a whole area as the subject detection areas in step S1001, and therefore the axial region 1103 is selected as the part for priority determination. Similarly, in the case of the dog 1101 in FIG. 13A, the axial region 1105 is selected as the part for priority determination. Meanwhile, in the case of FIG. 13B, the axial region 1113 is selected as the part for priority determination of the human 1112. Similarly, the axial region 1114 of the dog 1111 is selected.

In step S1003, the priority determination part 4031 determines whether or not to set priority for the defocus range on the basis of the part for priority determination selected in step S1002.

In the present embodiment, the determination regarding whether or not to set priority is made according to the area ratio of the subject detection area to the image. The priority determination part 4031 calculates the area from the information on the size of the subject detection area of the part for priority determination selected in step S1002, and divides the calculated area by the image size to calculate the area ratio of each part. If the calculated area ratio is equal to or greater than a threshold, the priority determination part 4031 performs the processing in step S1004. If the calculated area ratio is less than the threshold, or if a part for priority determination is not selected in step S1002, the priority determination part 4031 ends the priority setting processing in step S901. The threshold is set to 0.5, for example.

In the case of FIG. 13A, the parts for priority determination selected in step S1002 are the axial region 1103 of the human and the axial region 1105 of the dog, and if the threshold is set to 0.5 for example, the area ratio of the subject detection area to the image does not reach the threshold for either one of these parts. Accordingly, the priority setting processing in step S901 is ended. On the other hand, in FIG. 13B, the parts for priority determination selected in step S1002 are the axial region 1113 of the human and the axial region 1114 of the dog. If the area ratios are calculated in a manner similar to FIG. 13A, the area ratio of the axial region 1113 of the dog is equal to or greater than the threshold of 0.5, and the flow is advanced to the processing in step S1004.

The case where the subject detection area of a part for priority determination occupies a large portion of the image means that the subject is shot up close. The case where a subject is shot up close means that the subject is the main subject intended by the user, or in other words, the subject is highly likely to be a subject that the user wants to prioritize for focusing. In light of this, step S1003 is performed to determine whether or not to set priority for the defocus range.

In step S1004, the priority determination part 4031 sets priority for each of the defocus ranges for the parts determined to be combined in step S602. In the present embodiment, the priority determination part 4031 sets priority by changing the defocus ranges for the parts determined to be combined in step S602 on the basis of the subject having a part of which the area ratio is equal to or greater than the threshold in step S1003. More specifically, the priority determination part 4031 changes the defocus ranges for the parts determined to be combined in step S602 so that the defocus ranges for all parts are the same as a defocus range that serves as a reference. In this case, the defocus range of the subject having a part of which the area ratio is equal to or greater than the threshold in step S1003 serves as the reference. In other words, in the current step, the defocus ranges to be used for control of the imaging device 10 are changed so that the subject having a part of which the area ratio is equal to or greater than the threshold is in focus.

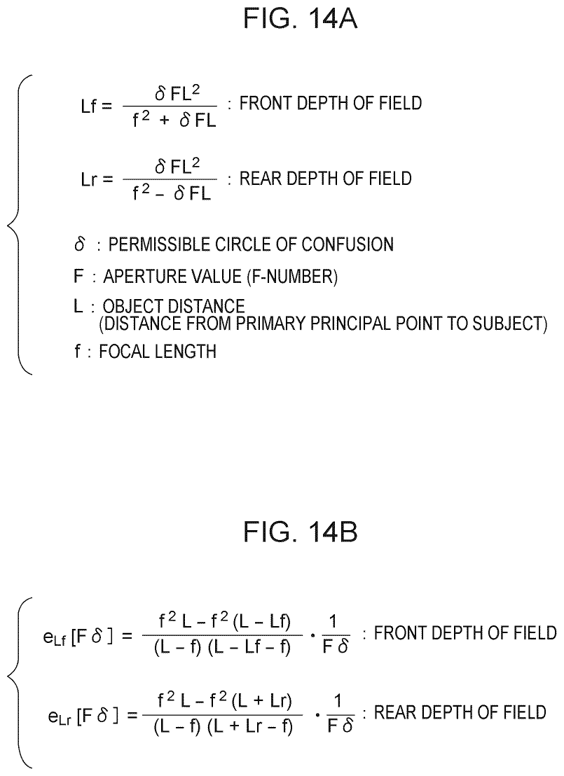

In FIG. 13E, the results of setting priority in the current step for the defocus range estimation results in FIG. 13D are represented in a schematic diagram. The line segments in FIG. 13E are the results of setting priority for the depth of field (DoF) calculated according to the formulas in FIGS. 14A and 14B and for the defocus ranges for the parts determined to be combined in step S602. As an example, consider the case where the parts determined to be combined in step S602 are the left eye 1115 of the dog and the axial region 1113 of the human, and in step S1003, it is determined to set priority for the human 1112. In the current step, priority is set for the axial region 1113 of the human by changing the defocus range for the left eye 1115 of the dog to be the same as the defocus range for the axial region 1113 of the human that serves as the reference. In the case of FIG. 13E, the priority setting in the current step causes the defocus range for the axial region 1113 of the human and the defocus range for the left eye 1115 of the dog to become the same. For this reason, in step S902 and subsequent steps performed by the range setting part 403, processing based on the defocus range of the axial region 1113 of the human is performed, and the control part 404 controls the image-taking lens 201 so that the axial region 1113 of the human is in focus. By determining a defocus range of a subject that serves as a reference in this way, the subject that the user wants to be in focus can be selected from among multiple subjects.

The priority of a defocus range may be set by comparing the defocus range to the depth of field and modifying the defocus range to be used for control of the imaging device 10. A method for computing the depth of field will be described with reference to FIGS. 14A and 14B. FIGS. 14A and 14B are formulas (approximation formulas) for calculating depth of field. Depth of field refers to the distance at which a photograph appears to be in focus, and is calculated in the system control part 102 using the formulas indicated in FIG. 14A. Information that serves as a reference for whether a subject is in focus or not, namely information pertaining to the permissible circle of confusion δ, and information pertaining to the set aperture value F (F-number at the time of image-taking) are stored in the memory 104.

Also, information pertaining to the focal length f and information pertaining to the object distance L is stored in a memory in the lens control part 205, with different values depending on the position of the image-taking lens 201. For this reason, the imaging device 10 receives the above information from the image-taking lens 201 by communication. The imaging device 10 calculates the depth of field on the basis of the received information. In the following description, a depth of field calculated by increasing the value of the aperture F by a certain value according to the method in FIGS. 14A and 14B is compared to the defocus range for a part selected in step S1002, and priority is set between the depth of field and the defocus range.

In FIG. 13F, the results of setting priority in step S1004 for the defocus range estimation results in FIG. 13D are represented in a schematic diagram. The line segments in FIG. 13F are the depth of field (DoF) calculated according to the formulas in FIGS. 14A and 14B and the depth of field (DoF (+1 step)) calculated by increasing the value of the aperture F by one step. The values of DoF and DoF+1 step are converted according to the formulas in FIG. 14B to allow for comparison to the defocus range estimation results.

The line segment of the defocus range for the axial region of the human 1112 in FIG. 13F represents the result of setting priority based on the depth of field of DoF+1 step over the defocus range for the human axial region in FIG. 13B. In other words, in FIG. 13F, priority is set for the defocus ranges such that the defocus range for the axial region of the human 1112 is limited to falling within the depth of field of DoF+1 step. Setting priority for defocus ranges in this way enables focusing control that accounts for how the more the subject detection area of a part for priority determination occupies a large portion of the image and the more a subject is shot up close, the more spread out is the estimated defocus range for the subject. If a subject area is shot up close, image-taking conditions with a shallow depth of field are assumed, because it is thought that the distance between the subject and the imaging device 10 is close and the focal length of the lens unit 200 is long. In this case, it is thought that even a slight spread of the subject in the depth direction will result in large differences in the defocus amount, and the defocus range estimation results in the defocus range estimation part 401 will be more spread out. If the defocus ranges indicated in S501 to S503 are combined on the basis of more spread-out defocus range estimation results and the control processing in S504 is performed, the accuracy of the focus and/or aperture control may decrease. By setting priority for the defocus ranges, it is possible to take an image in which any chosen subject is in focus, while accounting for the spread of the subject in the depth direction.

### OTHER EMBODIMENTS

The present disclosure is also achieved through execution of the following processing. That is, the processing is the result of supplying software (a program) for achieving the functions of the embodiments above to a system or a device via a network or any of various types of storage media, and having a computer (or a CPU, an MPU, or the like) in the system or the device read out and execute the program.

The embodiments above are all merely illustrations of specific examples of carrying out the present disclosure, and the technical scope of the present disclosure is not to be interpreted as being limited by the embodiments above. In other words, the present disclosure can be carried out in various forms without deviating from the technical concepts or the major features thereof.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-208064, filed Nov. 29, 2024, which is hereby incorporated by reference herein in its entirety.

What is claimed is:

1. A device for imaging a plurality of subjects of different types, the device comprising:
at least one processor; and
at least one memory having stored thereon instructions which, when executed by the at least one processor, cause the device at least to:
estimate a defocus range for each of the plurality of subjects;
set a combination of a plurality of the defocus ranges;
set a control defocus range based on the set combination of a plurality of the defocus ranges; and
control image-taking conditions of the device based on the control defocus range.

2. The device according to claim 1, wherein
respective positions of the plurality of subjects in a range imageable by the device are obtained as detection results, and
the estimation is performed based on the detection results.

3. The device according to claim 1, wherein
respective sizes of the plurality of subjects in a range imageable by the device are obtained as detection results, and
the estimation is performed based on the detection results.

4. The device according to claim 1, wherein the combination is set based on a selection made by a user from among a plurality of preset combinations of defocus ranges.

5. The device according to claim 1, the combination is set according to a trend of image-taking by a user.

6. The device according to claim 1, wherein the combination is set according to a result of the estimation.

7. The device according to claim 1, wherein
a defocus range is estimated for each of a plurality of portions of the plurality of subjects,
the plurality of portions include local areas and whole areas broader than the local areas, and
the defocus ranges corresponding to the local areas are treated as the defocus ranges to be combined from among the defocus ranges for the plurality of portions.

8. The device according to claim 2, wherein linking processing is performed to combine the plurality of subjects based on the Intersection over Union (IoU) between the subjects and the defocus ranges respectively corresponding to the subjects.

9. The device according to claim 3, wherein linking processing is performed to combine the plurality of subjects based on the Intersection over Union (IoU) between the subjects and the defocus ranges respectively corresponding to the subjects.

10. The device according to claim 8, wherein if more than one combination to be linked together exists, the linking processing prioritizes selection of a combination of subjects for which the defocus ranges are on a close-up side.

11. The device according to claim 9, wherein if more than one combination to be linked together exists, the linking processing prioritizes selection of a combination of subjects for which the defocus ranges are on a close-up side.

12. The device according to claim 1, wherein a range from the most close-up defocus range to the most far-away defocus range for the plurality of subjects is obtained as the control defocus range.

13. The device according to claim 1, wherein a range common to the defocus ranges for the plurality of subjects is set as the control defocus range.

14. The device according to claim 1, wherein a lens of the device is controlled to carry out control of a focus position.

15. The device according to claim 1, wherein depth of field is adjusted through control of an aperture.

16. The device according to claim 1, wherein
priority is determined for the respective defocus ranges for the plurality of subjects, and
the control defocus range is set based on a result of the determination.

17. A method for controlling a device, the method comprising:
estimating a defocus range for each of a plurality of subjects of different types;
setting a combination of a plurality of the defocus ranges;
setting a control defocus range based on the set combination of a plurality of the defocus ranges; and
controlling the device based on the control defocus range.

18. The method according to claim 17, wherein
respective positions of the plurality of subjects in a range imageable by the device are obtained as detection results, and
the estimation is performed based on the detection results.

19. A non-transitory computer-readable storage medium having stored thereon a program for causing a computer to perform a method for controlling a device, the method comprising:
estimating a defocus range for each of a plurality of subjects of different types;
setting a combination of a plurality of the defocus ranges;
setting a control defocus range based on the set combination of a plurality of the defocus ranges; and
controlling the device based on the control defocus range.

20. The non-transitory computer-readable storage medium according to claim 19, wherein
respective positions of the plurality of subjects in a range imageable by the device are obtained as detection results, and
the estimation is performed based on the detection results.
